(19) United States
(12) Patent Application Publication
(10) Pub. No.: US 2019/0335707 A1
(43) Pub. Date: Nov. 7, 2019

(54) AUTOMATIC FEED DEVICE

(71) Applicant: Ji-Rong YAN, Taichung City (TW)

(72) Inventor: Ji-Rong YAN, Taichung City (TW)

(21) Appl. No.: 16/402,666

(22) Filed: May 3, 2019

(30) Foreign Application Priority Data
May 3, 2018 (TW) 107115078

(51) Int. Cl. A01K 5/02; A01K 39/012

(52) U.S. Cl. CPC A01K 5/0241; A01K 39/012; A01K 5/0291

(57) ABSTRACT

An automatic feed device has a drive unit, a feed chimney, a feed unit mounted under the feed chimney and equipped with a case opening up and down for connection, a tubular sleeve deployed inside the case for accommodating a rotatable drum and opening up and down as an allocation for a feed inlet and a feed outlet, wherein the rotatable drum prepared with an impeller and a pair of round barriers for fixing the impeller between, the impeller having a plurality of blades arranged at equal angle, between the adjacent blades dividing several spaces in positional correspondence with the feed inlet and feed outlet and making rotation once driven by the drive unit. Therefore, the users can control the accurate amount for provender supply by manipulating the drive unit.

### BACKGROUND OF THE INVENTION

### 1. Field of the Invention

Modern people are engaged to the business as to neglect caring of their livestock or poultry and result in malnutrition and physical harm to the domestic animals. Therefore, there present automatic feed devices on the shelves for provender supply to the livestock or poultry in a periodic and quantitative manner. However, the feeding devices we have for now are complicated in structure and over a half of them employ a screw-like nozzle mechanism by controlling the screw's rotation angle which fails to offer an accurate quantity and are in need for improvement.

### 2. Description of the Related Art

This invention relates to a technique for feeding livestock or poultry; to be more specifically, is an automatic feed device having the merit of accurate supply quantity, and the function of periodically dosing amount and remote intelligent control.

### SUMMARY OF THE INVENTION

In view of this, this invention aims to provide an automatic feed device having the merit of accurate supply quantity and the function of integrating intelligent control at ease.

This invention provides an automatic feed device has a drive unit, a feed chimney, a feed unit mounted under the feed chimney, the feed unit having a case opening up and down for connection, a tubular sleeve deployed inside the case and a rotatable drum disposed inside the tubular sleeve, wherein the tubular sleeve is unfolded up and down for allocating a feed inlet and a feed outlet, the feed inlet is equipped with an impeller and a pair of round barriers for fixing the impeller between, the impeller has a plurality of blades arranged at equal angle in positional correspondence with the feed inlet and the feed outlet and making rotation once driven by the drive unit.

By way of the users' manipulation on the drive unit to force the impeller rotating periodically or non-periodically at a predetermine angle and enable the dosing amount of the provender dropping off from the feed outlet as to proceed the task of feeding livestock or poultry which is easy to hand on and is accurate on quantity supply.

### BRIEF DESCRIPTION OF THE DRAWINGS

FIG. 1 illustrates a perspective view of an automatic feed device in accordance with this invention.

FIG. 2 illustrates an exploded perspective view of the automatic feed device in accordance with this invention.

FIG. 3 illustrates a perspective view of a feed inlet of the automatic feed device in accordance with this invention.

FIG. 4 illustrates a cross-sectional view of the feed inlet in accordance with FIG. 3.

### DETAILED DESCRIPTION OF PREFERRED EMBODIMENTS

Hereinafter provides an embodiment along with the drawings for further specifically illustrating the embodiment and performance to this invention.

The provided embodiment of this invention is an automatic feed device 10 composing of a feed chimney 20, a drive unit 30 and a feed unit 40.

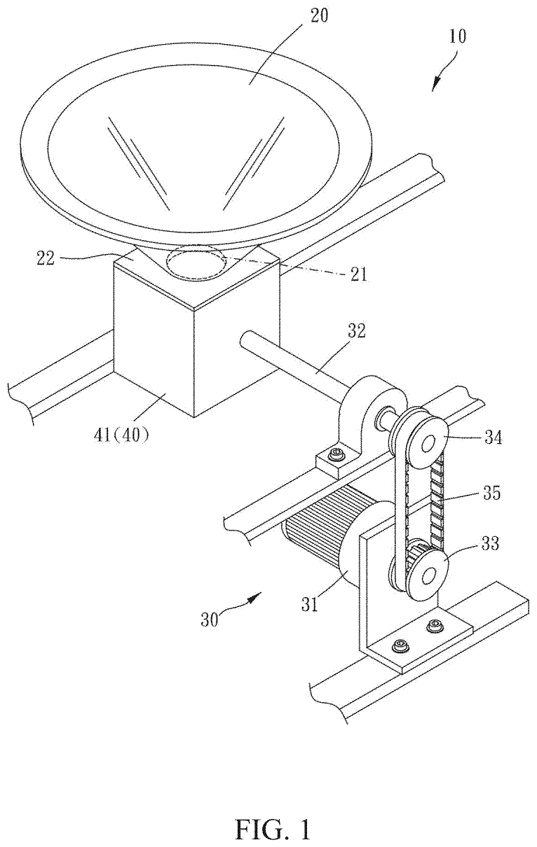

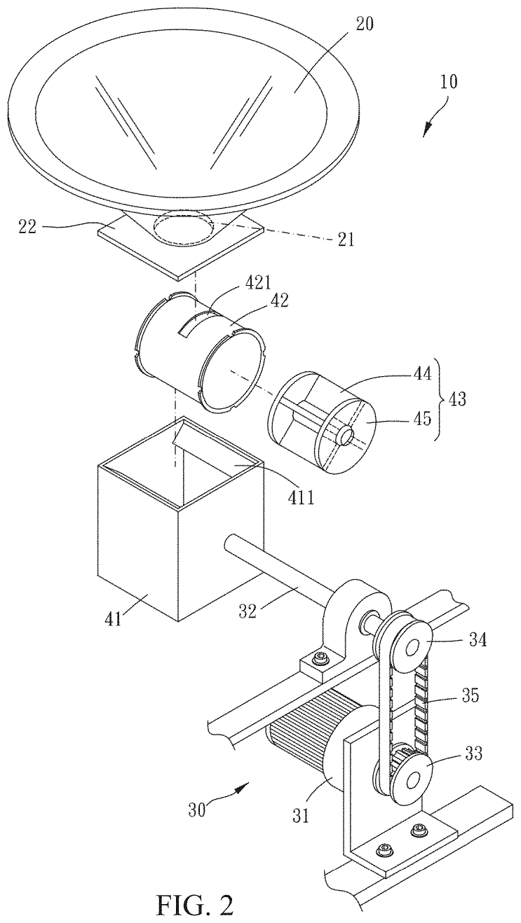

Firstly, please refer to FIG. 1 and FIG. 2, the feed chimney 20 forms roughly shape of funnel having a feed inlet 21 on the bottom end, on the up side of a feed unit 40 deployed with the feed chimney 20 facilitating provender's entrance from the feed inlet 21 into the feed unit 40. Besides, on the up side of the feed chimney 20 may further install a feed bucket (figures not shown) for bulk storage in sealed condition, and on the down side of the feed chimney 20 is equipped with a cover 22 for closing the top side of the feed unit 40.

A drive unit 30 has a drive source 31 (which is a motor in this embodiment) and an output shaft 32 making a rotational motion to a feed unit 40 once driven by the drive source 31. In this embodiment, between the drive source 31 and the output shaft 32 deployed with a driving wheel 33, a driven wheel 34 and a driving belt 35, wherein the driving wheel 33 is disposed on the drive source 31 and driven by thereof, the driven wheel 34 connected to one side of the output shaft 32 and the driving belt 35 girdling around the driving wheel 33 and the driven wheel 34 for power transmission.

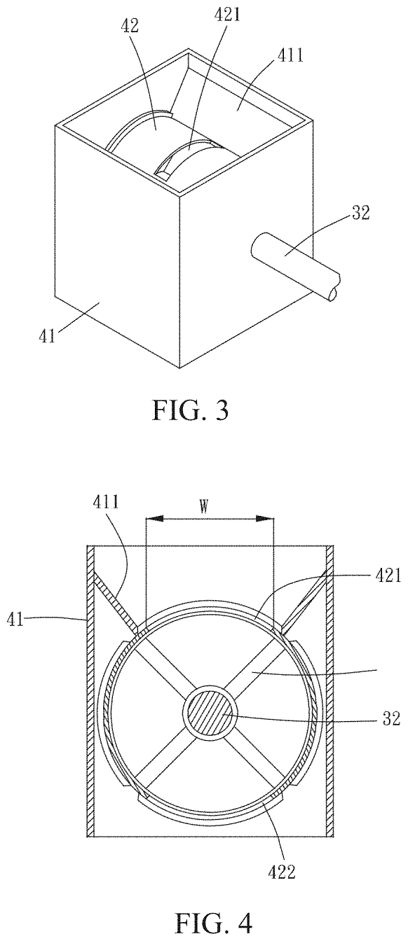

Please refer to FIG. 2 to FIG. 4, the feed unit 40 composes of a case 41, a tubular sleeve 42 and a rotatable drum 43. The case 41 is a square container opening up and down for connection with a pair of flip covers on top side introducing the provender's entrance from the feed inlet 21 as shown in FIG. 2 to FIG. 4. At the same time, the cover 22 under the feed chimney 20 is used to seal top of the case 41. A tubular sleeve 42 is an empty cylinder with opening on its both sides and located inside of the case 41, the tubular sleeve 42 are deployed with a feed inlet 421 and a feed outlet 422 separately on its center top and its center bottom.

The rotatable drum 43 composes of an impeller 44 and a pair of round barriers for fixing the impeller 44 between and both of them have the same diameter. Besides, the impeller 44 connects the output shaft 32 and rotates once driven by the drive unit 30. The impeller 44 is composed by a plurality of blades 441, and between the adjacent blades 441 are spaces with openings in positional correspondence with the feed inlet 421 or the feed outlet 422. In this embodiment, the number of the blades 441 of the impeller 44 are four and arrange at equal angle for having equal volume of the spaces; of course, the number of the blades may be varied per the skillful person's request under other circumstances.

What's worth mentioning is that the width of the feed inlet 421 and the width of adjacent impeller 441 are approximately equal, which means the diameter of the barriers is equal to the inner diameter of the tubular sleeve 42. In this way, the provender can make a smooth entrance to the spaces between the adjacent impeller 441 without jammed situation, and the amount of provender filling up entirely the spaces between the adjacent impeller 441 is equal to the amount dropped off from the feed outlet 422 as the impeller 44 turns 90 degrees. To be more specifically, the flip covers 411 and the impeller 441 may be dispositioned simultaneously on the same virtual plane for the provender smoothly dropping into the spaces between the adjacent impeller 441.

Therefore, the users may preset the start time of the drive unit 30 and the rotation angle of the output shaft 32 in order to control the impeller 44 of the rotatable drum 43 making a periodic rotation at a predetermined angle and to drop off the provender from the feed outlet 422 as to process feed of the livestock or poultry.

The drive unit 30 in aforementioned embodiment may as well be equipped with an intelligent controller (figures not shown) to realize the function of remote control with adjustable parameter to the users for process feed task.

To sum up, the configuration of this invention is comparatively simple however equipped with the function of accurate supply quantity and also waiving jammed problem.

What is claimed is:

1. An automatic feed device comprises a drive unit and a feed chimney which characteristics is:
a feed unit mounted under the feed chimney, said feed unit having a case opening up and down for connection, a tubular sleeve disposed inside of the case, and a rotatable drum located inside of the tubular sleeve;
wherein the case has a pair of flip covers extending to the periphery of the tubular sleeve forming a closing figure, said tubular sleeve forming an empty cylinder with openings on the top for feed inlet and on the bottom for feed outlet, the rotatable drum having an impeller and a pair of round barriers for fixing the impeller between and rotating along with the impeller, the diameter of barriers being equal to the inner diameter of the tubular sleeve, the impeller composing of a plurality of blades arranged at equal angle and a number of spaces between the adjacent blades, the spaces being in positional correspondence with the feed inlet and the feed outlet, and the width of the feed inlet being equal to that of the adjacent blades and making rotation once driven by the drive unit.

2. An automatic feed device as claimed in claim 1, wherein the feed chimney forms a funnel shape equipped with a feed inlet on its bottom side.

3. An automatic feed device as claimed in claim 2, wherein the feed chimney deployed with a cover on its bottom.

4. An automatic feed device as claimed in claim 1, wherein the drive unit has a drive source and an output shaft driven by the drive source for transmitting rotational movement to the rotatable drum.

5. An automatic feed device as claimed in claim 4, wherein the drive source and the output shaft are deployed with a driving wheel, a driven wheel and a driving belt between, the driving wheel is disposed on the drive source and driven by the drive source, the driven wheel connected to one side of the output shaft, and the driving belt girdling around the driving wheel and the driven wheel.

6. An automatic feed device as claimed in claim 1, wherein one of the flip covers and one of the blades are dispositioned simultaneously on the same virtual plane.

7. An automatic feed device as claimed in claim 1, wherein the drive source disposed with an intelligent controller.
